(19) United States
(12) Patent Application Publication
(10) Pub. No.: US 2021/0245741 A1
(43) Pub. Date: Aug. 12, 2021

(54) EMERGENCY VEHICLE AVOIDANCE CONTROL APPARATUS AND EMERGENCY VEHICLE AVOIDANCE CONTROL METHOD

(71) Applicant: HONDA MOTOR CO., LTD., Minato-ku (JP)

(72) Inventor: Masahiko ASAKURA, WAKO-SHI (JP)

(21) Appl. No.: 17/166,246

(22) Filed: Feb. 3, 2021

(30) Foreign Application Priority Data
Feb. 6, 2020 (JP) 2020-018583

(51) Int. Cl. B60W 30/09; G08G 1/16; B60W 30/095

(52) U.S. Cl. CPC B60W 30/09; B60W 30/0953; B60W 30/0956; G08G 1/166

(57) ABSTRACT

A vehicle control apparatus includes an emergency vehicle position acquiring section that acquires position information of an emergency vehicle; a road structure acquiring section that acquires a structure of a user's own vehicle travel road on which a vehicle is traveling; and an avoidance control section that performs avoidance control causing the vehicle to get out of the way, if the position information of the emergency vehicle has been acquired. In a case where the emergency vehicle is an oncoming vehicle and the road has a median strip, the avoidance control section suppresses the avoidance control when there is no opening in the median strip between the vehicle and the emergency vehicle.

### CROSS-REFERENCE TO RELATED APPLICATION

This application is based upon and claims the benefit of priority from Japanese Patent Application No. 2020-018583 filed on Feb. 6, 2020, the contents of which are incorporated herein by reference.

### BACKGROUND OF THE INVENTION

### Field of the Invention

The present invention relates to an emergency vehicle avoidance control apparatus and an emergency vehicle avoidance control method for performing avoidance control that causes a user's own vehicle to get out of the way when an emergency vehicle approaches the user's own vehicle.

### Description of the Related Art

Japanese Laid-Open Patent Publication No. 2010-237792 discloses a driving assistance apparatus that does not provide guidance for an avoidance operation in a case where an emergency vehicle is approaching the user's own vehicle from the front and the road on which the user's own vehicle is traveling has a median strip.

### SUMMARY OF THE INVENTION

However, in a case where the user's own vehicle does not get out of the way when there is an opening in the median strip, there is a concern that the travel of the emergency vehicle entering through the opening into the lane in which the user's own vehicle is traveling will be obstructed by the user's own vehicle.

It is an objective of the present invention to provide an emergency vehicle avoidance control apparatus and an emergency vehicle avoidance control method that make it possible to prevent a user's own vehicle from obstructing the travel of an emergency vehicle.

A first aspect of the present invention is an emergency vehicle avoidance control apparatus including a position acquiring section that acquires position information of an emergency vehicle; a road structure acquiring section that acquires a structure of a user's own vehicle travel road on which a vehicle is traveling; and an avoidance control section that performs avoidance control causing the vehicle to get out of the way, if the position information of the emergency vehicle has been acquired, wherein, in a case where the structure of the user's own vehicle travel road includes a median strip and a position of the emergency vehicle is on an opposite side of the user's own vehicle in a manner to sandwich the median strip, the avoidance control section suppresses the avoidance control when there is no opening in the median strip between the user's own vehicle and the emergency vehicle.

A second aspect of the present invention is an emergency vehicle avoidance control method including a position acquiring step of acquiring position information of an emergency vehicle; a road structure acquiring step of acquiring a structure of a user's own vehicle travel road on which a user's own vehicle is traveling; an avoidance control step of performing avoidance control causing the user's own vehicle to get out of the way, if the position information of the emergency vehicle has been acquired; and an avoidance control suppression step of, in a case where a structure of the user's own vehicle travel road includes a median strip and a position of the emergency vehicle is on an opposite side of the user's own vehicle in a manner to sandwich the median strip, suppressing the avoidance control when there is no opening in the median strip between the user's own vehicle and the emergency vehicle.

According to the present invention, it is possible to provide an emergency vehicle avoidance control apparatus and an emergency vehicle avoidance control method that make it possible to prevent a user's own vehicle from obstructing the travel of an emergency vehicle.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of a vehicle;

FIG. 2 is a block diagram of the vehicle; and

FIG. 3 is a flow chart showing the flow of an emergency vehicle avoidance process performed by a vehicle control apparatus.

### DESCRIPTION OF THE PREFERRED EMBODIMENTS

### First Embodiment

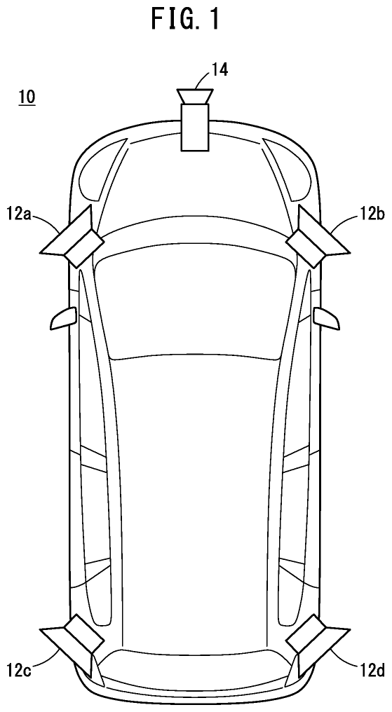

FIG. 1 is a schematic diagram of a vehicle 10 according to the present embodiment. The vehicle 10 corresponds to a user's own vehicle of the present invention. The vehicle 10 of the present embodiment is an engine automobile, a hybrid automobile, an electric automobile, or the like, and is not particularly limited.

The vehicle 10 includes microphones 12a to 12d that gather sound outside the vehicle 10. The microphone 12a gathers sound mainly from a region to the front left of the vehicle 10. The microphone 12b gathers sound mainly from a region to the front right of the vehicle 10. The microphone 12c gathers sound mainly from a region to the rear left of the vehicle 10. The microphone 12d gathers sound mainly from a region to the rear right of the vehicle 10.

The vehicle 10 includes a camera 14 that captures images outside the vehicle 10. As an example, the camera 14 captures images of moving bodies such as other vehicle and pedestrians, the shape of the road, obstacles, lanes on the road, road signs, and the like. In FIG. 1, one camera 14 is provided on the front of the vehicle 10, but a plurality of cameras 14 may be provided instead. Furthermore, the cameras 14 may be provided not only at the front of the vehicle 10, but also at other locations such as the rear side, the left side, and the right side of the vehicle 10. Instead of or in addition to the camera 14, the vehicle 10 may include a radar, LiDAR, ultrasonic sensor, infrared sensor, or the like that acquires information corresponding to distances between the vehicle 10 and objects.

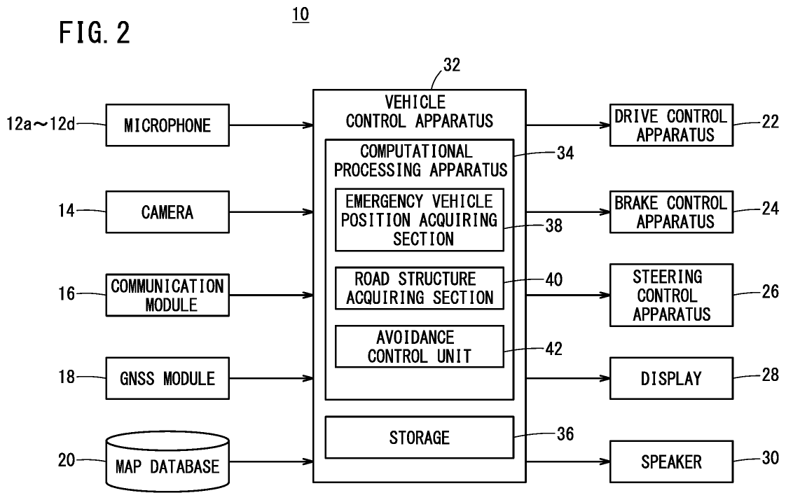

FIG. 2 is a block diagram of the vehicle 10 according to the present embodiment. The vehicle 10 includes, in addition to the microphones 12a to 12d and the camera 14 described above, a communication module 16, a global navigation satellite system (GNSS) module 18, a map database 20, a drive control apparatus 22, a brake control apparatus 24, a steering control apparatus 26, a display 28, a speaker 30, and a vehicle control apparatus 32.

The communication module 16 is a module that performs wireless communication, and is used for inter-vehicle communication. The GNSS module 18 acquires position information of the vehicle 10. The map database 20 stores map information.

The drive control apparatus 22 controls drive force generated by a drive apparatus, such as an engine or drive motor (not shown in the drawings) of the vehicle 10. The brake control apparatus 24 controls braking force realized by a braking apparatus, such as hydraulic brakes or regenerative brakes (not shown in the drawings) of the vehicle 10. The steering control apparatus 26 controls a steering amount of a steering wheel (not shown in the drawings) of the vehicle 10.

The display 28 provides information to an occupant of the vehicle 10, using video or the like. The speaker 30 provides information to the occupant of the vehicle 10, using audio or the like.

The vehicle control apparatus 32 includes a computational processing apparatus 34 and a storage 36. The vehicle control apparatus 32 corresponds to an emergency vehicle avoidance control apparatus of the present invention. The computational processing apparatus 34 includes a processor such as a CPU (not shown in the drawings) and a storage medium such as a RAM. The storage 36 is a non-transitory tangible computer-readable storage medium.

The computational processing apparatus 34 includes an emergency vehicle position acquiring section 38, a road structure acquiring section 40, and an avoidance control unit (avoidance control section) 42.

The emergency vehicle position acquiring section 38 acquires position information of an emergency vehicle, via the communication module 16. The position information of the emergency vehicle is information provided by the emergency vehicle via inter-vehicle communication, and is information such as the current position of the emergency vehicle and the scheduled travel route of the emergency vehicle. The position information of the emergency vehicle may be provided from a server installed on the ground, instead of via inter-vehicle communication.

The road structure acquiring section 40 acquires the structure of the road on which the vehicle 10 is traveling (referred to below as the user's own vehicle travel road), from the map database 20. The road structure shows intersections, median strips, openings in median strips, elevated roads, bridges, underpasses, and the like. Furthermore, the road structure acquiring section 40 may acquire the road structure based on an image outside the vehicle 10, which is captured by the camera 14.

The avoidance control unit 42 performs avoidance control causing the vehicle 10 to move to the edge of the road and temporarily stop, via the drive control apparatus 22, the brake control apparatus 24, and the steering control apparatus 26, if the position of the emergency vehicle has been acquired by the emergency vehicle position acquiring section 38.

The emergency vehicle position acquiring section 38, the road structure acquiring section 40, and the avoidance control unit 42 are realized by having a processor execute a program stored in the storage 36.

### [Emergency Vehicle Avoidance Process]

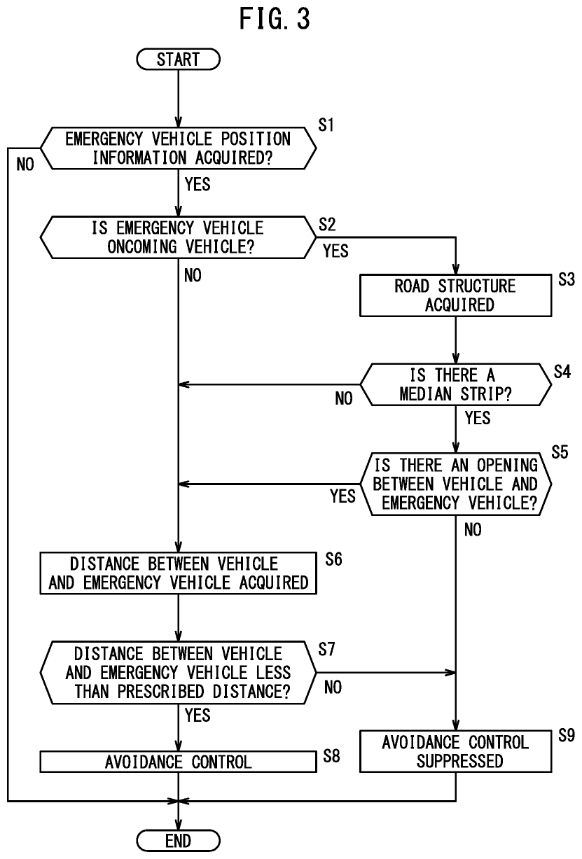

FIG. 3 is a flow chart showing the flow of the emergency vehicle avoidance process performed by the vehicle control apparatus 32. The emergency vehicle avoidance process is performed at prescribed periods during automated driving control, in which driving of the vehicle 10 is performed by a system without the occupant making driving manipulations, and during assisted driving control, in which the system assists with the driving manipulations made by the occupant.

At step S1, the emergency vehicle position acquiring section 38 judges whether the emergency vehicle position information has been acquired. If the emergency vehicle position information has been acquired, the process moves to step S2, and if the emergency vehicle position information has not been acquired, the emergency vehicle avoidance process ends.

At step S2, the emergency vehicle position acquiring section 38 judges whether the emergency vehicle is an oncoming vehicle (opposing vehicle) with respect to the vehicle 10. If the emergency vehicle is an oncoming vehicle, the process moves to step S3, and if the emergency vehicle is not an oncoming vehicle, the process moves to step S6.

At step S3, the road structure acquiring section 40 acquires the structure of the user's own vehicle travel road, and moves to step S4.

At step S4, the road structure acquiring section 40 judges whether the user's own vehicle travel road has a structure including a median strip. If the user's own vehicle travel road has a structure including a median strip, the process moves to step S5, and if the user's own vehicle travel road does not have a structure including a median strip, the process moves to step S6.

At step S5, the road structure acquiring section 40 judges whether there is an opening in the median strip between the vehicle 10 and the emergency vehicle. If there is an opening in the median strip between the vehicle 10 and the emergency vehicle, the process moves to step S6, and if there is no opening in the median strip between the vehicle 10 and the emergency vehicle, the process moves to step S9. The opening in the median strip is installed at the position of an intersection, for example. As another example, the opening in the median strip is installed to let the vehicle 10 cross the opposing traffic lane and enter the premises of a roadside shop positioned alongside the opposing traffic lane.

At step S6, the emergency vehicle position acquiring section 38 acquires the distance between the vehicle 10 and the emergency vehicle, and moves to step S7. The emergency vehicle position acquiring section 38 acquires the distance between the vehicle 10 and the emergency vehicle based on the position information of the vehicle 10 acquired via the GNSS module 18 and the position information of the emergency vehicle acquired via the communication module 16.

At step S7, the emergency vehicle position acquiring section 38 judges whether the distance between the vehicle 10 and the emergency vehicle is less than a prescribed distance. If the distance between the vehicle 10 and the emergency vehicle is less than the prescribed distance, the process moves to step S8, and if the distance between the vehicle 10 and the emergency vehicle is greater than or equal to the prescribed distance, the process moves to step S9.

At step S8, the avoidance control unit 42 performs the avoidance control causing the vehicle 10 to move to the edge of the road and temporarily stop, and ends the emergency vehicle avoidance process. If the emergency vehicle is an oncoming vehicle and there is an opening in the median strip between the vehicle 10 and the emergency vehicle, the avoidance control unit 42 performs the avoidance control causing the vehicle 10 to temporarily stop before reaching the opening.

At step S9 occurring after it has been judged by the road structure acquiring section 40 at step S5 that there is no opening in the median strip, or at step S9 occurring after it has been judged by the emergency vehicle position acquiring section 38 at step S7 that the distance between the vehicle 10 and the emergency vehicle is equal to or more than the prescribed distance, the avoidance control unit 42 suppresses the avoidance control and ends the emergency vehicle avoidance process. Suppressing the avoidance control refers to causing the movement amount when the vehicle 10 is moved to the edge of the road to be less than the movement amount caused by the avoidance control of step S8, for example. As another example, suppressing the avoidance control refers to setting the speed of the vehicle 10 to be less than a prescribed speed, without temporally stopping the vehicle 10. As another example, suppressing the avoidance control refers to not performing the avoidance control.

Due to this emergency vehicle avoidance process, if the emergency vehicle position acquiring section 38 acquires the position information of the emergency vehicle and the distance between the vehicle 10 and the emergency vehicle is less than the prescribed distance, the avoidance control causing the vehicle 10 to get out of the way is performed. However, when the emergency vehicle is an oncoming vehicle and the user's own vehicle travel road has a structure including a median strip, the avoidance control is suppressed. On the other hand, even when the emergency vehicle is an oncoming vehicle and the user's own vehicle travel road has a structure including a median strip, the avoidance control is not suppressed if there is an opening between the vehicle 10 and the emergency vehicle. When the emergency vehicle passes by the vehicle 10, the automated driving control or assisted driving control described above is reinstated.

At step S8 above, the avoidance control unit 42 controls the drive control apparatus 22, the brake control apparatus 24, and the steering control apparatus 26 to cause the vehicle 10 to move to the edge of the road and temporarily stop, as the avoidance control. Instead, at step S8, the avoidance control unit 42 may control at least one of the display 28 and the speaker 30 to notify the occupant of the vehicle 10 about the approach of the emergency vehicle, as the avoidance control. In such a case, suppressing the avoidance control at step S9 refers to delaying the timing of the notification or not providing the notification, for example. As another example, suppressing the avoidance control at step S9 refers to changing an image displayed in the display 28, reducing the volume of the audio emitted from the speaker 30, or the like.

At step S8 above, the avoidance control unit 42 controls the drive control apparatus 22, the brake control apparatus 24, and the steering control apparatus 26 to cause the vehicle 10 to move to the edge of the road and temporarily stop, as the avoidance control. In addition to this, at step S8, the avoidance control unit 42 may control at least one of the display 28 and the speaker 30 to notify the occupant of the vehicle 10 about the approach of the emergency vehicle, as the avoidance control. In such a case, suppressing the avoidance control at step S9 refers to delaying the timing of the notification, not providing the notification, changing an image displayed in the display 28, reducing the volume of the audio emitted from the speaker 30, or the like.

### [Operation and Effects]

Conventional technology has been proposed in which the vehicle 10 can obtain, via inter-vehicle communication or the like, the position information of the emergency vehicle emitted by the emergency vehicle. With this technology, when the vehicle 10 acquires the position information of the emergency vehicle, the occupant of the vehicle 10 is guided to avoid the vehicle 10. On the other hand, even when the vehicle 10 acquires the position information of the emergency vehicle, if there is a median strip between the vehicle 10 and the emergency vehicle, the above guidance is not provided. However, even in a case where there is a median strip between the vehicle 10 and the emergency vehicle which is an oncoming vehicle, when there is an opening in the median strip such as at an intersection, there is a concern that if the vehicle 10 does not get out of the way, the travel of the emergency vehicle entering through the opening into the lane in which the vehicle 10 is traveling will be obstructed.

Therefore, the vehicle control apparatus 32 of the present embodiment includes the emergency vehicle position acquiring section 38 that acquires the position information of the emergency vehicle, the road structure acquiring section 40 that acquires the structure of the user's own vehicle travel road, and the avoidance control unit 42 that performs the avoidance control to move the vehicle 10 out of the way if the position information of the emergency vehicle has been acquired. Then, if the structure of the user's own vehicle travel road includes a median strip and the emergency vehicle is an oncoming vehicle, the avoidance control unit 42 suppresses the avoidance control performed when there is no opening in the median strip between the vehicle 10 and the emergency vehicle. Due to this, even in a case where there is a median strip between the vehicle 10 and the emergency vehicle that is an oncoming vehicle, when there is an opening in the median strip such as at an intersection or the like, the vehicle 10 gets out of the way and does not obstruct the travel of the emergency vehicle.

Furthermore, if the structure of the road on which the vehicle 10 is traveling includes a median strip and the emergency vehicle is an oncoming vehicle, when there is an opening in the median strip between the vehicle 10 and the emergency vehicle, the avoidance control unit 42 of the present embodiment performs the avoidance control causing the vehicle 10 to temporarily stop before reaching the opening. Due to this, even in a case where there is a median strip between the vehicle 10 and the emergency vehicle that is an oncoming vehicle, when there is an opening in the median strip such as at an intersection, the vehicle 10 gets out of the way and does not obstruct the travel of the emergency vehicle.

Furthermore, the avoidance control unit 42 of the present embodiment suppresses the avoidance control when the distance between the vehicle 10 and the emergency vehicle is greater than or equal to the prescribed distance. Due to this, in a case where the structure of the road on which the vehicle 10 is traveling includes a median strip and the emergency vehicle is an oncoming vehicle, even when there is an opening in the median strip between the vehicle 10 and the emergency vehicle, it is possible to suppress the avoidance control when the distance between the vehicle 10 and the emergency vehicle is greater than or equal to the prescribed distance.

### Technical Concepts Understandable from the Embodiments

The following is a record of the technical concepts that can be understood from the above embodiments.

An emergency vehicle avoidance control apparatus (32) includes a position acquiring section (38) that acquires position information of an emergency vehicle; a road structure acquiring section (40) that acquires a structure of a user's own vehicle travel road on which a vehicle (10) is traveling; and an avoidance control section (42) that performs avoidance control causing the vehicle (10) to get out of the way, if the position information of the emergency vehicle has been acquired, wherein, in a case where the structure of the user's own vehicle travel road includes a median strip and a position of the emergency vehicle is on an opposite side of the user's own vehicle in a manner to sandwich the median strip, the avoidance control section suppresses the avoidance control when there is no opening in the median strip between the user's own vehicle and the emergency vehicle.

In the emergency vehicle avoidance control apparatus described above, in a case where the structure of the user's own vehicle travel road includes the median strip and the position of the emergency vehicle is on the opposite side of the user's own vehicle in a manner to sandwich the median strip, when there is an opening between the user's own vehicle and the emergency vehicle, the avoidance control section may perform the avoidance control causing the user's own vehicle to temporarily stop before reaching the opening.

In the emergency vehicle avoidance control apparatus described above, the avoidance control section may suppress the avoidance control when a distance between the user's own vehicle and the emergency vehicle is greater than or equal to a prescribed distance.

An emergency vehicle avoidance control method includes a position acquiring step of acquiring position information of an emergency vehicle; a road structure acquiring step of acquiring a structure of a user's own vehicle travel road on which a user's own vehicle is traveling; an avoidance control step of performing avoidance control causing the user's own vehicle to get out of the way, if the position information of the emergency vehicle has been acquired; and an avoidance control suppression step of, in a case where a structure of the user's own vehicle travel road includes a median strip and a position of the emergency vehicle is on an opposite side of the user's own vehicle in a manner to sandwich the median strip, suppressing the avoidance control when there is no opening in the median strip between the user's own vehicle and the emergency vehicle.

What is claimed is:

1. An emergency vehicle avoidance control apparatus comprising one or more processors, wherein the one or more processors:
acquire position information of an emergency vehicle;
acquire a structure of a user's own vehicle travel road on which a user's own vehicle is traveling;
perform avoidance control causing the user's own vehicle to get out of a way, if the position information of the emergency vehicle has been acquired; and
in a case where the structure of the user's own vehicle travel road includes a median strip and a position of the emergency vehicle is on an opposite side of the user's own vehicle in a manner to sandwich the median strip, suppress the avoidance control when there is no opening in the median strip between the user's own vehicle and the emergency vehicle.

2. The emergency vehicle avoidance control apparatus according to claim 1, wherein the one or more processors:
in a case where the structure of the user's own vehicle travel road includes the median strip and the position of the emergency vehicle is on the opposite side of the user's own vehicle in a manner to sandwich the median strip, when there is an opening in the median strip between the user's own vehicle and the emergency vehicle, perform the avoidance control causing the user's own vehicle to temporarily stop before reaching the opening.

3. The emergency vehicle avoidance control apparatus according to claim 1, wherein the one or more processors:
suppress the avoidance control when a distance between the user's own vehicle and the emergency vehicle is greater than or equal to a prescribed distance.

4. An emergency vehicle avoidance control method comprising:
acquiring position information of an emergency vehicle;
acquiring a structure of a user's own vehicle travel road on which a user's own vehicle is traveling;
performing avoidance control causing the user's own vehicle to get out of a way, if the position information of the emergency vehicle has been acquired; and
in a case where the structure of the user's own vehicle travel road includes a median strip and a position of the emergency vehicle is on an opposite side of the user's own vehicle in a manner to sandwich the median strip, suppressing the avoidance control when there is no opening in the median strip between the user's own vehicle and the emergency vehicle.
